(19) United States
(12) Patent Application Publication
(10) Pub. No.: US 2008/0018727 A1
(43) Pub. Date: Jan. 24, 2008

(54) Optical beam scanning apparatus, optical beam scanning method, optical beam scanning program, image forming apparatus, image forming method, image forming program

(75) Inventors: Daisuke Ishikawa, Mishima-shi (JP); Koji Tanimoto, Tagata-gun (JP); Kenichi Komiya, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/491,737

(22) Filed: Jul. 24, 2006

(51) Int. Cl. B41J 2/435

(52) U.S. Cl. 347/224

(57) ABSTRACT

In the optical beams scanning apparatus and an image forming apparatus having this optical beam scanning apparatus according to this invention, a light emitting unit emits plural laser beams set at a predetermined output in advance, and a scanning unit deflects the emitted plural laser beams and scans with them. A laser beam output setting unit arranges the light emitting unit so that scanning positions of the plural laser beams are arrayed in time series in a main scanning direction on the same line, and sets the output of laser beams cast onto a photoconductor by using the plural laser beams. A writing unit writes an image to the photoconductor with the preset output of the laser beams cast onto the photoconductor, using the plural laser beams used for scanning. With the optical beam scanning apparatus and the image forming apparatus having this optical beam scanning apparatus according to this invention, the output of laser beams cast onto a photoconductive drum can be controlled at a high speed.

### BACKGROUND OF THE INVENTION

1. Technical Field of the Invention

This invention relates to an optical beam scanning apparatus, an optical beam scanning method, an optical beam scanning program for this optical beam scanning apparatus, an image forming apparatus having this optical beam scanning apparatus, an image forming method, and an image forming program for this image forming apparatus, and particularly to an optical beam scanning apparatus, an optical beam scanning method and an optical beam scanning program for this optical beam scanning apparatus that enable control of an output of a laser beam cast to a photoconductive drum, an image forming apparatus having this optical beam scanning apparatus, an image forming method, and an image forming program for this image forming apparatus.

2. Related Art

Recently, image forming apparatuses such as digital copy machines and laser printers that perform image formation by scanning exposure with a laser beam and an electrophotographic process have been proposed.

In these image forming apparatuses, an optical beam scanning apparatus is provided that casts a laser beam (optical beam) to the surface of a photoconductive drum and scans it with the laser beam, thereby forming an electrostatic latent image on the photoconductive drum. The optical beam scanning apparatus has, for example, a laser oscillating unit that generates a laser beam, a polygon mirror that deflects the laser beam outputted from the laser oscillating unit toward the photoconductive drum and thus causes the laser beam to scan the photoconductive drum, an fθ lens, and the like.

In such an image forming apparatus, toner development is carried out on the electrostatic latent image formed on the photoconductive drum, and the toner-developed image is ultimately transferred as a recording image to a recording paper. Therefore, to form an even and uniform recording image, it is necessary to form an electrostatic latent image with uniform intensity on the photoconductive drum, and it is important to stabilize the intensity of the laser beam on the photoconductive drum.

Thus, generally, the laser oscillating unit of the image forming apparatus is equipped with an APC (auto power control) function, and in the laser oscillating unit, the output of the laser oscillating unit is controlled to be constant while the intensity of the laser beam is monitored by a photodetector provided within the laser oscillating unit (or a photodetector provided near the laser oscillating unit). This enables stabilization of the intensity of the laser beam on the photoconductive drum and formation of an even and uniform recording image.

Meanwhile, in the image forming apparatus, generally, the pulse width or pulse position is adjusted by using a pulse width modulation (PWM) system, thereby forming required gradation levels (plural gradation levels) corresponding to image data on the photoconductive drum. However, recently, a technique (so-called real-time APC) has been proposed in which, by utilizing the APC function, the intensity of the laser beam on the photoconductive drum is monitored, then the output of the laser beam cast to the photoconductive drum is changed into a main scanning direction, and an electrostatic latent image of required gradation levels based on the laser beam of required intensity is formed on the photoconductive drum while varying the intensity of the laser beam into the main scanning direction within one scanned line.

JP-A-2000-71510 proposes a technique of storing correction data in advance and controlling the output of the laser oscillating unit in accordance with the scanning position on the photoconductive drum by using this correction data.

Recently, as techniques of realizing higher resolution of an image and techniques of realizing higher speeds of printing (for example, a technique of switching ON/OFF the output of the laser oscillating unit at a high speed when scanning one line, and thus forming an image) have progressed quickly, adaptation to these techniques is required.

However, to adapt the technique of varying, in real time, the output of the laser beam cast to the photoconductive drum utilizing the APC function to these techniques, a device (for example, D/A converter) used for changing the output of the laser oscillating unit must be set at a high speed to correspond to the high speed. There is a problem that it is extremely difficult to realize the adaptation by using the existing devices.

Such a problem is also true in the case of adapting the technique proposed in JP-A-2000-71510 to the techniques of realizing higher resolution of an image and the techniques of realizing higher speeds of printing.

### SUMMARY OF THE INVENTION

In view of the foregoing circumstances, it is an object of this invention to provide an optical beam scanning apparatus, an optical beam scanning method and an optical beam scanning program for this optical beam scanning apparatus that enable high-speed control of an output of a laser beam cast to a photoconductive drum, an image forming apparatus having this optical beam scanning apparatus, an image forming method, and an image forming program for this image forming apparatus.

In order to solve the above problem, an optical beam scanning apparatus according to an aspect of this invention includes: light emitting means for emitting plural laser beams set at a predetermined output in advance; scanning means for deflecting the plural laser beams emitted by the light emitting means and scanning with them; output setting means for arranging the light emitting means so that scanning positions of the plural laser beams by the scanning means are arrayed in time series in a main scanning direction on the same line, and for setting an output of the laser beams cast onto a photoconductor by using the plural laser beams; and writing means for writing an image to the photoconductor with the output of the laser beams cast onto the photoconductor set by the output setting means, using the plural laser beams used for the scanning by the scanning means.

In order to solve the above problem, an optical beam scanning method according to an aspect of this invention includes the steps of: emitting plural laser beams set at a predetermined output in advance; deflecting the plural laser beams emitted by the light emitting processing and scanning with them; arranging light emitting means so that scanning positions of the plural laser beams by the scanning processing are arrayed in time series in a main scanning direction on the same line, and setting an output of the laser beams cast onto a photoconductor by using the plural laser beams; and writing an image to the photoconductor with the output of the laser beams cast onto the photoconductor set by the output setting processing, using the plural laser beams used for the scanning in the scanning processing.

In order to solve the above problem, an optical beam scanning program for an optical beam scanning apparatus according to an aspect of this invention causes a computer to execute the steps of: emitting plural laser beams set at a predetermined output in advance; deflecting the plural laser beams emitted by the light emitting processing and scanning with them; arranging light emitting means so that scanning positions of the plural laser beams by the scanning processing are arrayed in time series in a main scanning direction on the same line, and setting an output of the laser beams cast onto a photoconductor by using the plural laser beams; and writing an image to the photoconductor with the output of the laser beams cast onto the photoconductor set by the output setting processing, using the plural laser beams used for the scanning in the scanning processing.

In order to solve the above problem, an image forming apparatus according to an aspect of this invention includes: light emitting means for emitting plural laser beams set at a predetermined output in advance; scanning means for deflecting the plural laser beams emitted by the light emitting means and scanning with them; output setting means for arranging the light emitting means so that scanning positions of the plural laser beams by the scanning means are arrayed in time series in a main scanning direction on the same line, and for setting an output of the laser beams cast onto a photoconductor by using the plural laser beams; and writing means for writing an image to the photoconductor with the output of the laser beams cast onto the photoconductor set by the output setting means, using the plural laser beams used for the scanning by the scanning means.

In order to solve the above problem, an image forming method according to an aspect of this invention includes the steps of: emitting plural laser beams set at a predetermined output in advance; deflecting the plural laser beams emitted by the light emitting processing and scanning with them; arranging light emitting means so that scanning positions of the plural laser beams by the scanning processing are arrayed in time series in a main scanning direction on the same line, and setting an output of the laser beams cast onto a photoconductor by using the plural laser beams; and writing an image to the photoconductor with the output of the laser beams cast onto the photoconductor set by the output setting processing, using the plural laser beams used for the scanning in the scanning processing.

In order to solve the above problem, an image forming program for an image forming apparatus having an optical beam scanning apparatus according to an aspect of this invention causes a computer to execute the steps of: emitting plural laser beams set at a predetermined output in advance; deflecting the plural laser beams emitted by the light emitting processing and scanning with them; arranging light emitting means so that scanning positions of the plural laser beams by the scanning processing are arrayed in time series in a main scanning direction on the same line, and setting an output of the laser beams cast onto a photoconductor by using the plural laser beams; and writing an image to the photoconductor with the output of the laser beams cast onto the photoconductor set by the output setting processing, using the plural laser beams used for the scanning in the scanning processing.

In the optical beams scanning apparatus, the optical beam scanning method and the optical beam scanning program for this optical beam scanning apparatus according to an aspect of this invention, plural laser beams set at a predetermined output in advance are emitted, and the emitted plural laser beams are deflected and used for scanning. Light emitting means is arranged so that scanning positions of the plural laser beams are arrayed in time series in a main scanning direction on the same line, and an output of the laser beams cast onto a photoconductor is set by using the plural laser beams. Using the plural laser beams used for scanning, an image is written to the photoconductor with the preset output of the laser beams cast onto the photoconductor.

In the image forming apparatus having the optical beam scanning apparatus, the image forming method, and the image forming program for the image forming apparatus according to an aspect of this invention, plural laser beams set at a predetermined output in advance are emitted, and the emitted plural laser beams are deflected and used for scanning. Light emitting means is arranged so that scanning positions of the plural laser beams are arrayed in time series in a main scanning direction on the same line, and an output of the laser beams cast onto a photoconductor is set by using the plural laser beams. Using the plural laser beams used for scanning, an image is written to the photoconductor with the preset output of the laser beams cast onto the photoconductor.

### BRIEF DESCRIPTION OF THE DRAWINGS

In the attached drawings,

FIG. 1 is a view showing a configuration of an image forming apparatus having an optical beam scanning apparatus according to this invention;

FIG. 2 is a view showing the positional relation between a laser optical system unit and a photoconductive drum of FIG. 1;

FIG. 3 is a block diagram showing an internal configuration of the image forming apparatus of FIG. 1;

FIG. 4 is a block diagram showing a detailed internal configuration of a laser control unit of FIG. 3;

FIG. 5 is a block diagram showing a functional configuration that can be executed in a first embodiment of an image forming apparatus according to this invention;

FIG. 6 is a flowchart for explaining power control processing in the image forming apparatus of FIG. 5;

FIG. 7 is an explanatory view for explaining a laser beam output setting method in laser beam output setting processing in step S1 of FIG. 6;

FIG. 8 is a timing chart up to a point when a laser beam is emitted from a semiconductor laser oscillator in the image forming apparatus of FIG. 5;

FIG. 9 is an explanatory view for explaining another laser beam output setting method in the laser beam output setting processing in step S1 of FIG. 6;

FIG. 10 is a block diagram showing another detailed internal configuration of the laser control unit of FIG. 3;

FIG. 11 is an explanatory view for explaining a pulse width modulation method in PWM of FIG. 10;

FIG. 12 is a block diagram showing a functional configuration that can be executed in a second embodiment of an image forming apparatus according to this invention;

FIG. 13 is a flowchart for explaining power control processing in the image forming apparatus of FIG. 12;

FIG. 14 is an explanatory view for explaining transmission loss due to an fθ lens or the like;

FIG. 15 is an explanatory view for explaining a power modulation method for compensating for transmission loss due to an fθ lens or the like;

FIG. 16 is a flowchart for explaining another power control processing in the image forming apparatus of FIG. 5;

FIG. 17 is an explanatory view for explaining a laser beam output setting method in laser beam output setting processing in step S21 of FIG. 16;

FIG. 18 is an explanatory view for explaining another laser beam output setting method in the laser beam output setting processing in step S21 of FIG. 16; and

FIG. 19 is an explanatory view for explaining a configuration of a surface emitting laser that can be applied to this invention.

### DETAILED DESCRIPTION OF THE PREFERRED EMBODIMENTS

Hereinafter, embodiments of this invention will be described with reference to the drawings.

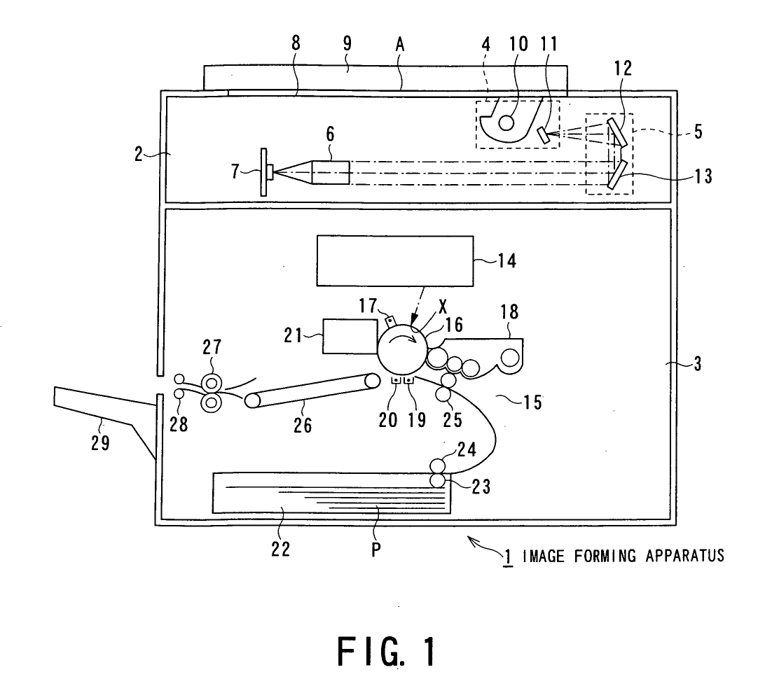

FIG. 1 shows a configuration of an image forming apparatus 1 according to this invention.

As shown in FIG. 1, the image forming apparatus 1 includes, for example, a scanner unit 2 as image reading means and a printer driving unit 3 as image forming means.

In the scanner unit 2, an original A is put with its face down on an original board glass 8, and as a cover 9 for fixing an original provided to freely open and close is closed, the original A is pressed against the original board glass 8 with a predetermined pressure. The original A is irradiated from a light source 10 and reflected light from the original A goes through mirrors 11 to 13 and a condensing lens 6, and is converged onto a sensor surface of a photoelectric converter 7.

A first carriage 4 formed by the light source 10 and the mirror 11, and a second carriage 5 formed by the mirror 12 and the mirror 13 are driven by a carriage driving motor (not shown) so that their optical path lengths are always constant. As they move from right to left synchronously with a reading timing signal, irradiation light from the light source 10 scans the original A.

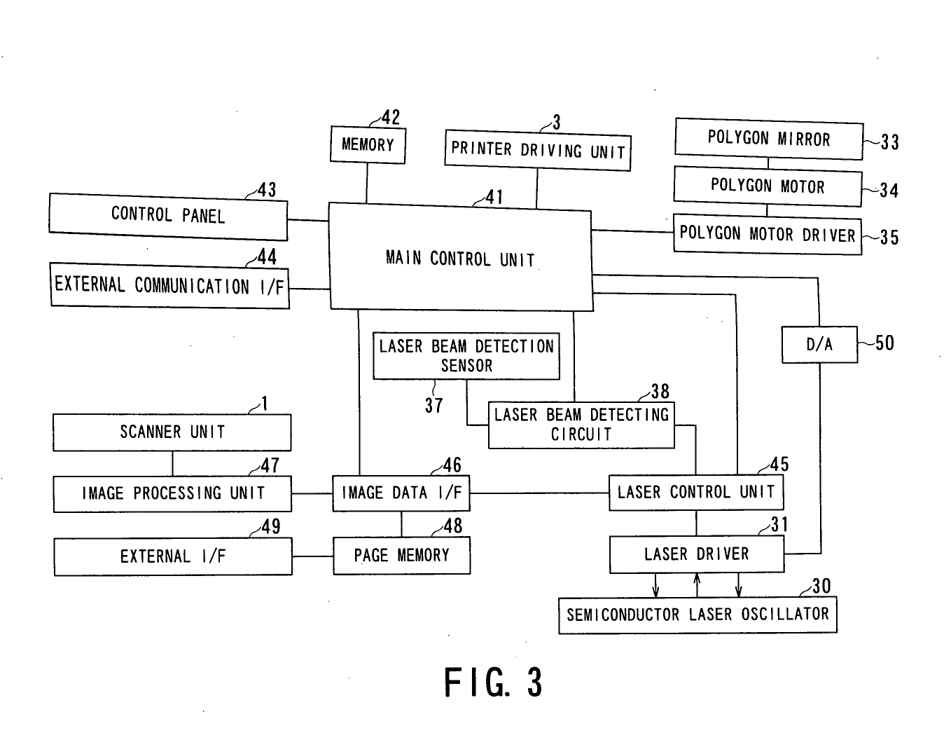

In this manner, the original A set on the original board glass 8 is sequentially read by each line, and is converted to an analog signal by the photoelectric converter 7 in accordance with the intensity of an optical signal, which is the reflected light. After that, the converted analog signal is converted to a digital signal (image data) representing the density of an image by an image processing unit (image processing unit 47 of FIG. 3), and outputted to a laser optical system unit 14.

The printer driving unit 3 includes an image forming unit 15 that is a combination of the laser optical system unit 14 and an electrophotographic system capable of forming an image on a paper P, which is an image forming target medium.

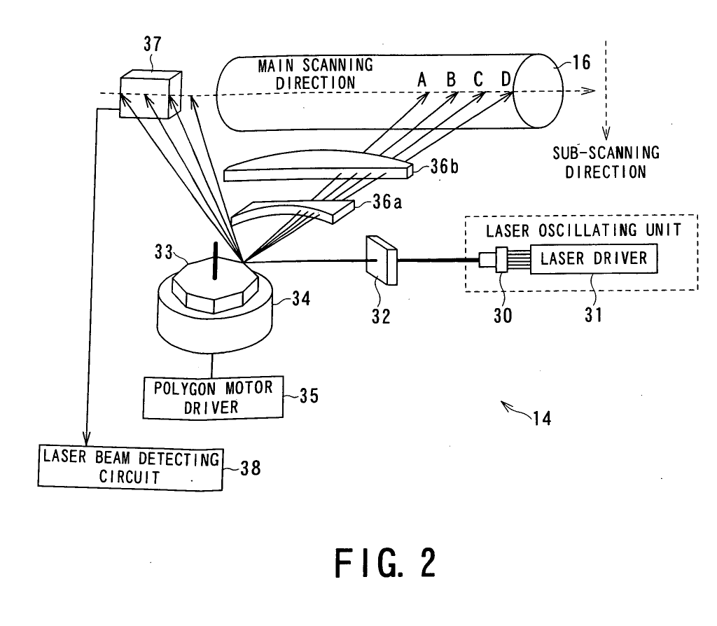

In the printer driving unit 3, the image data of the original A read by the scanner unit 2 is converted to laser beams from semiconductor laser oscillators (semiconductor laser oscillators 31 of FIG. 2).

The Plural Semiconductor Laser Oscillators (semiconductor laser oscillators 31 of FIG. 2) provided in the laser optical system unit 14 carry out light emitting operation based on a laser modulation signal outputted form a laser control unit (laser control unit 45 of FIG. 3), and emit plural laser beams. These laser beams are reflected (deflected) by a polygon mirror (polygon mirror 33 of FIG. 2) to become scanning light and is outputted outside of the laser optical system unit 14.

The plural laser beams outputted from the laser optical system unit 14 are converged as spot light with required resolution at an exposure position X on a photoconductive drum 16 as an image carrier, and scan the photoconductive drum 16 in a main scanning direction. Moreover, as the photoconductive drum 16 rotates, an electrostatic latent image corresponding to the image data is formed in a sub-scanning direction on the photoconductive drum 16.

The direction (direction of the rotation axis of the photoconductive drum 16) into which each laser beam is deflected (for scanning) by the polygon mirror (polygon mirror 33 of FIG. 2) is referred to as “main scanning direction”. The direction orthogonal to the main scanning direction and also to an axial line that is a reference for the deflection of the laser beams by the polygon mirror such that the laser beams directed for scanning (deflected) by the polygon mirror are in the main scanning direction, is referred to as “sub-scanning direction”.

A charger 17 for charging the surface of the photoconductive drum 16, a developing unit 18, a transfer charger 19, a separation charger 20 and a cleaner 21 are arranged on the periphery of the photoconductive drum 16, which is an image carrier for forming an image. The photoconductive drum 16 is rotationally driven at a predetermined outer circumferential speed by a driving motor, not shown, and is charged by the charger 17 provided to face its surface.

When the exposure position X on the charged photoconductive drum 16 is irradiated with light, the potential of the irradiated part is lowered and the lowered potential forms an image (electrostatic latent image) on the photoconductive drum 16. Next, toner as a developer from the developing unit 18 is developed on the photoconductive drum 16. By the development, a toner image is formed on the photoconductive drum 16, and the toner image is transferred by the transfer charger 19 onto the paper P supplied at proper timing from a paper feed system (paper feed cassette 22, paper feed roller 23 and separation roller 24) at a transfer position.

The paper feed system separates each sheet of the papers P in the paper feed cassette 22 provided at the bottom by the paper feed roller 23 and the separation roller 24. After that, the paper P is sent out to a registration roller 25 and supplied to the transfer position at predetermined timing. Downstream of the transfer charger 19, a paper carrying mechanism 26, a fixing unit 27, and a discharge roller 28 for discharging the paper P on which an image has been formed, are provided. Thus, the toner image is fixed by the fixing unit 27 to the paper P to which the toner image has been transferred, and then the paper P is discharged to an external discharge tray 29 via the discharge roller 28.

As for the photoconductive drum 16 that has completed transfer to the paper P, the residual toner is removed by the cleaner 21, and the photoconductive drum 16 restores its initial state and enters the standby state for the next image formation.

Repeating the process operations as described above, the image forming operation is continuously carried out.

Referring to FIG. 2, the positional relation between the laser optical system unit 16 and the photoconductive drum 16 of FIG. 1 will be described.

The laser optical system unit 14 has semiconductor laser oscillators 30 provided therein, for example, as four laser beam emitting means. As the respective laser beams simultaneously carry out image formation of one scanning line each, image formation can be carried out at a high speed without increasing the number of rotations of the polygon mirror 33.

First, each of the four-channel semiconductor laser oscillators 30 is driven by a laser driver 31 on the basis of a laser modulation signal for each channel. Laser beams outputted from the semiconductor laser oscillators 30 pass through a collimating lens, not shown, and then pass through a half-mirror 32 and become incident on the polygon mirror 33 as a rotary polyhedral mirror.

The polygon mirror 33 is rotated at a constant speed by a polygon motor 34 driven by a polygon motor driver 35. Thus, reflected light (deflected light) from the polygon mirror 33 becomes scanning line to scan in a predetermined direction at an angular velocity defined by the number of rotations of the polygon motor 34, then passes through fθ lenses 36a and 36b, and are caused to scan a light receiving surface of a laser beam detection sensor 37 as laser beam passing position detecting means and laser light quantity detecting means and the photoconductive drum 16 at a constant speed.

The laser driver 31 is equipped with an APC (auto power control) function for each channel (for each semiconductor laser oscillator 30) and causing the semiconductor laser oscillators 30 to emit laser beams while controlling the output of each of the semiconductor laser oscillators 30 to maintain preset intensity of laser beams on the photoconductive drum 16.

The laser beam detection sensor 37 is provided near an edge of the photoconductive drum 16 so that its light receiving surface becomes equivalent to the surface of the photoconductive drum 16. The laser beam detection sensor 37 detects the passing position (passing timing) of laser beams, generates a detection signal, and supplies the generated detection signal to a laser beam detecting circuit 38.

The laser beam detecting circuit 38 acquires the detection signal from the laser beam detection sensor 37 and controls the light emission timing of the semiconductor laser oscillators 30 (control of the image forming position in the main scanning direction) on the basis of the acquired detection signal.

FIG. 3 shows an internal configuration of the image forming apparatus of FIG. 1. The elements corresponding to those in the configuration of FIG. 1 are denoted by the same numerals and therefore will not be described further in order to avoid repetition.

As shown in FIG. 3, in the image forming apparatus 1, a main control unit 41 including a CPU (central processing unit) or the like executes various processing in accordance with various application programs stored in a memory 42 including a ROM (read-only memory) and a RAM (random access memory) or the like, and also generates various control signals and supplies them to the respective units, thereby controlling the image forming apparatus 1 as a whole. The memory 42 properly stores necessary data for the main control unit 41 to execute various processing.

In addition to the memory 42, the printer driving unit 3, the polygon motor driver 35, the laser beam detecting circuit 38, a control panel 43, an external communication interface 44, a laser control unit 45, an image data interface 46, and a D/A converter 50 are connected to the main control unit 41. The image data interface 46 is connected to the laser control unit 45. An image processing unit 47 and a page memory 48 are connected to the image data interface 46, and also the laser driver 31 is connected thereto. The scanner unit 2 is connected to the image processing unit 47, and an external interface 49 is connected to the page memory 48.

Next, a flow of image data when forming an image will be described.

In the case of a copy machine operation, first, when an original A is set on the original board glass 8, the image data of the original A is read by the scanner unit 2 and the read image data is supplied to the image processing unit 47. The image processing unit 47 acquires the image data of the original A supplied from the scanner unit 2 and performs, for example, shading correction, various filtering processing, gradation processing and gamma correction, which are known techniques, to the acquired image data. The processed image data is stored into the page memory 38 in accordance with the need as in the printing of plural copies or the like. The main control unit 41 also stores image data transferred thereto from the external interface 49, into the page memory 48.

The image processing unit 47 supplies the processed image data to the laser control unit 45 in the laser optical system unit 14 via the image interface 46.

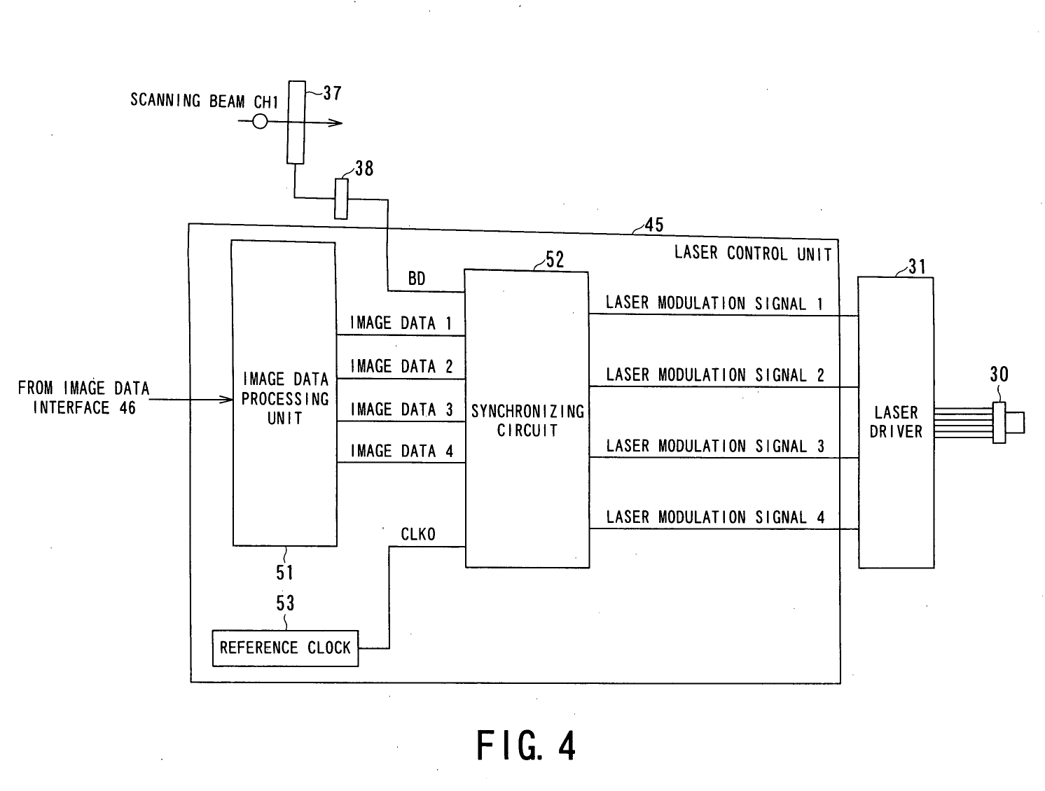

FIG. 4 shows a detailed internal configuration of the laser control unit 45 of FIG. 3.

As shown in FIG. 4, the laser control unit 45 includes an image data processing unit 51, a synchronizing circuit 52, and a reference clock 53.

The image data processing unit 51 acquires image data (pixel data) from the image processing unit 47 via the image data interface 46, allocates the acquired image data to each of the semiconductor laser oscillators 30, and supplies the allocated image data 1 to 4 to the synchronizing circuit 52.

The synchronizing circuit 52 acquires the image data (image data 1 to 4) for each of the semiconductor laser oscillators 30 supplied from the image data processing unit 51, and generates a new reference clock synchronous with a detection signal (BD) supplied from the laser beam detecting circuit 38 on the basis of a reference clock (CLKO) supplied from the reference clock 53.

The synchronizing circuit 52 synchronizes the acquired image data (image data 1 to 4) for each of the semiconductor laser oscillators 30 with the generated new reference clock, and outputs the synchronized image data as laser modulation signals (laser modulation signals 1 to 4) to the laser driver 31.

Also, the synchronizing circuit 52 is provided with a sample timer for causing the semiconductor laser oscillators 30 to compulsorily emit light in a non-image forming area (where an image will not be formed) on the photoconductive drum 16 and thus controlling the outputs of the semiconductor laser oscillators 30, and a logical circuit for causing the semiconductor laser oscillators 30 to emit light on the laser beam detection sensor 37 and thus detecting the position in the main scanning direction.

The laser driver 31 constantly acquires the laser modulation signals inputted from the laser control unit 45 and causes the semiconductor laser oscillators 30 to emit laser beams on the basis of the acquired laser modulation signals.

Since the image data is outputted while it is synchronized with the scanning timing with the laser beams in this manner, an image is formed at a desired position that is synchronized in the main scanning direction.

The control panel 43 is a user interface for a user to input the start of a duplication operation, the number of sheets and the like.

The polygon motor driver 35 is a driver that drives the polygon motor 34 for rotating, at a predetermined speed, the polygon mirror 33 that perform scanning with the laser beams. The main control unit 41 controls the polygon motor driver 35 to switch start of rotation, stop of rotation and the number of rotations of the polygon motor 34.

The memory 42 stores various kind of information necessary for the control by the main control unit 41. For example, circuit characteristics (offset quantity of an amplifier) for detecting the scanning position of the laser beams, the scanning order of the laser beams and the like are stored in advance. Also, the memory 42 properly stores necessary data for the main control unit 41 to execute various processing.

Meanwhile, in order to adapt the technique of varying, in real time, output of laser beams cast onto the photoconductive drum 16 by using the APC function, to the technique of realizing higher resolution of an image and the technique of realizing a higher speed of printing, the device (for example, D/A converter) used for modulating the output of the laser oscillating unit must be set at a high speed to correspond to the higher speed.

Thus, the laser optical system unit 14 including the semiconductor laser oscillators 30 is arranged so that plural laser beams scan the same line on the photoconductive drum 16 at predetermined intervals. Specifically, as shown in FIG. 2, the scanning positions of the laser beams from the semiconductor laser oscillators 30 of four channels are arranged at predetermined intervals in time series in the main scanning direction on the same line, such as scanning positions A, B, C and D. In this case, the outputs (quantities of light) of the semiconductor laser oscillators 30 are preset so that the respective laser beams at the scanning positions A to D have predetermined intensities (beam powers). For example, based on the output of the semiconductor laser oscillator 30 of the first channel corresponding to the scanning position A, the output of the semiconductor laser oscillator 30 of the second channel corresponding to the scanning position B, the output of the semiconductor laser oscillator 30 of the third channel corresponding to the scanning position C and the output of the semiconductor laser oscillator 30 of the fourth channel corresponding to the scanning position D are preset in ascending order (that is, the outputs of the semiconductor laser oscillators 30 of the four channels are preset to hold the output of the first channel<the output of the second channel<the output of the third channel<the output of the fourth channel). Of course, all the outputs of the semiconductor laser oscillators 30 of the four channels need not be different. For example, the output of the semiconductor laser oscillator 30 of the first channel corresponding to the scanning position A and the output of the semiconductor laser oscillator 30 of the fourth channel corresponding to the scanning position D may be the same first output (for example, 5 mW or the like), and the output of the semiconductor laser oscillator 30 of the second channel corresponding to the scanning position B and the output of the semiconductor laser oscillator 30 of the third channel corresponding to the scanning position C may be the same second output (for example, 4 mW) that is different from the first output.

Next, using the semiconductor laser oscillators 30 of the four channels set at the predetermined outputs, the same line is scanned while switching on/off the outputs of the semiconductor laser oscillators 30 of each channel at predetermined positions on the basis of the image data. This enables high-speed control of the outputs of the laser beams cast onto the photoconductive drum 16 and consequently enables high-speed control of the intensities (beam powers) of the laser beams on the photoconductive drum 16. Hereinafter, a first embodiment of this invention using this power control method will be described.

### First Embodiment

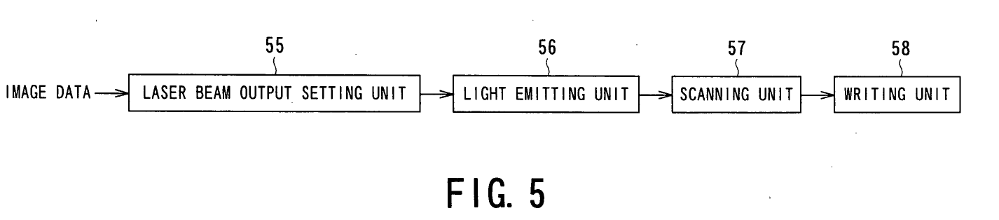

FIG. 5 shows a functional configuration that can be executed by the first embodiment of the image forming apparatus 1 according to this invention.

A laser beam output setting unit 55 includes, for example, the image data processing unit 51, the synchronizing circuit 52 and the reference clock 53 of FIG. 4. The laser beam output setting unit 55 acquires image data supplied from the image processing unit 47 via the image data interface 46, and synchronizes the acquired image data (image data 1 to 4) for each semiconductor laser oscillator 30 with a new reference clock generated on the basis of a reference clock supplied from the reference clock 53. On the basis of the synchronized image data, the laser beam output setting unit 55 generates a laser beam output setting signal for switching on/off the outputs of the semiconductor laser oscillators 30 of the respective channels at predetermined positions and thereby varying and setting the outputs of the laser beams cast onto the photoconductive drum 16, so that the output distribution of the laser beams cast onto the photoconductive drum 16 becomes a predetermined output distribution, and the laser beam output setting unit 55 supplies the generated laser beam output setting signal to a light emitting unit 56. This laser beam output setting signal is included in a laser modulation signal supplied to the light emitting unit 56.

The light emitting unit 56 includes, for example, the laser driver 31, the semiconductor laser oscillators 30 and the like. The light emitting unit 56 acquires the laser beam output setting signal supplied from the laser beam output setting unit 55, and emits laser beams of preset different outputs so that the laser beams of the preset different outputs are cast to predetermined positions on the photoconductive drum 16, on the basis of the acquired laser beam output setting signal.

A scanning unit 57 includes, for example, the polygon mirror 33, the polygon motor 34, and the polygon motor driver 35 and the like. The scanning unit 57 deflects the laser beams emitted by the light emitting unit 56 at a predetermined speed and scans the photoconductive drum 16 with the deflected laser beams.

A writing unit 58 includes, for example, the fθ lenses 38 (38a and 38b), the photoconductive drum 16 and the like. The writing unit 58 irradiates the charged photoconductive drum 16 with the laser beams used for scanning by the scanning unit 57, lowers the potential of the irradiated part, and forms an image (electrostatic latent image) on the photoconductive drum 16 by the lowered potential, thus writing a desired image.

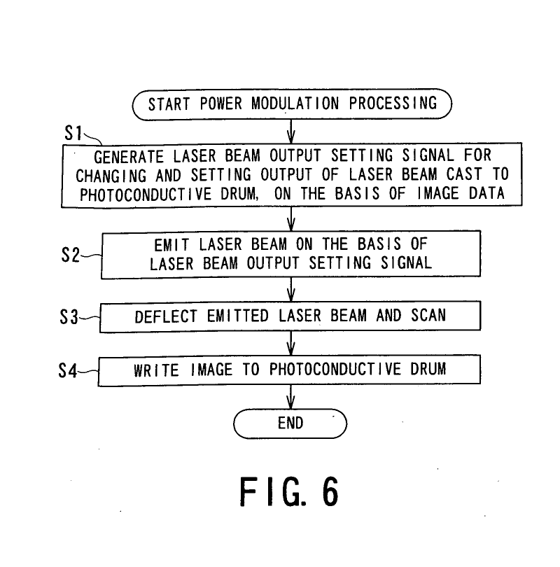

Next, the power control processing in the image forming apparatus 1 of FIG. 5 will be described with reference to the flowchart of FIG. 6.

In step S1, the laser beam output setting unit 55 acquires image data supplied from the image processing unit 47 via the image data interface 46, and synchronizes the acquired image data (image data 1 to 4) for each semiconductor laser oscillator 30 with a new reference clock generated on the basis of a reference clock supplied from the reference clock 53. On the basis of the synchronized image data, the laser beam output setting unit 55 generates a laser beam output setting signal for switching on/off the outputs of the semiconductor laser oscillators 30 of the respective channels at predetermined positions and thereby varying and setting the outputs of the laser beams cast onto the photoconductive drum 16, so that the output distribution of the laser beams cast onto the photoconductive drum 16 becomes a predetermined output distribution.

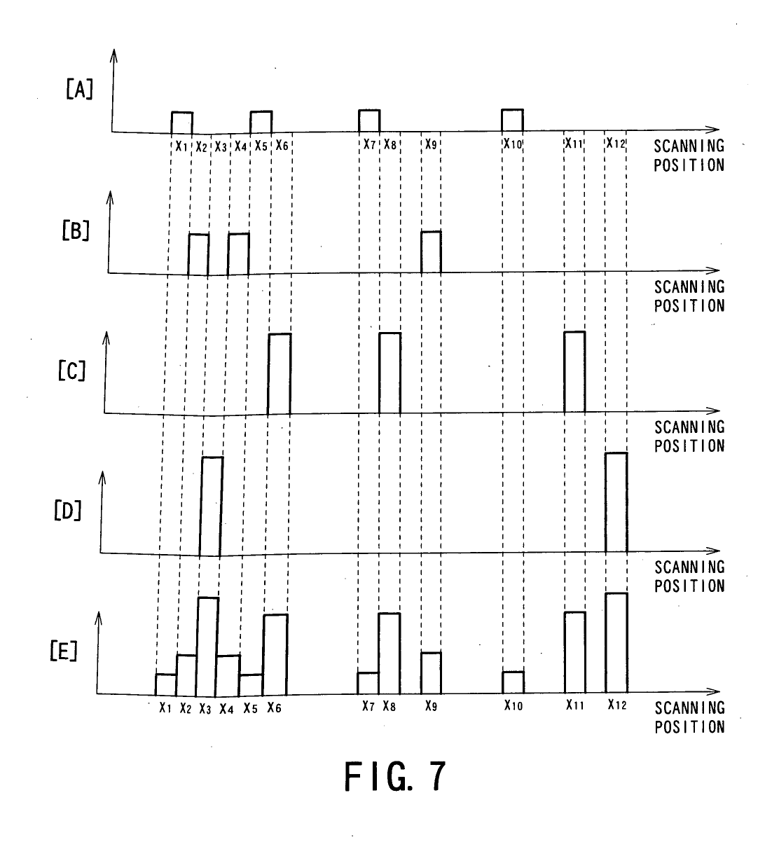

Specifically, on the basis of the synchronized image data, a laser beam output setting signal is generated such that a laser beam is cast from the semiconductor laser oscillator 30 of the first channel having the smallest output of laser beam of the semiconductor laser oscillators 30 of the four channels, for example, at scanning positions X₁, X₅, X₇ and X₁₀ on the photoconductive drum 16 as shown in [A] of FIG. 7. Similarly, a laser beam output setting signal is generated such that a laser beam is cast from the semiconductor laser oscillator 30 of the second channel having the third largest output of laser beam of the semiconductor laser oscillators 30 of the four channels, for example, at scanning positions X₂, X₄ and X₉ on the photoconductive drum 16 as shown in [B] of FIG. 7. A laser beam output setting signal is generated such that a laser beam is cast from the semiconductor laser oscillator 30 of the third channel having the second largest output of laser beam of the semiconductor laser oscillators 30 of the four channels, for example, at scanning positions X₆, X₈ and X₁₁ on the photoconductive drum 16 as shown in [C] of FIG. 7. A laser beam output setting signal is generated such that a laser beam is cast from the semiconductor laser oscillator 30 of the fourth channel having the largest output of laser beam of the semiconductor laser oscillators 30 of the four channels, for example, at scanning positions X₃ and X₁₂ on the photoconductive drum 16 as shown in [D] of FIG. 7.

The laser beam output setting unit 55 outputs the generated laser beam output setting signals to the laser driver 31.

In step S2, the light emitting unit 56 acquires the laser beam output setting signals supplied form the laser beam output setting unit 55, and emits laser beams of the preset and predetermined outputs so that the laser beams of the preset and predetermined outputs are cast to the predetermined positions on the photoconductive drum 16, on the basis of the acquired laser beam output setting signals.

That is, a laser beam is cast from the semiconductor laser oscillator 30 of the first channel so that a laser beam having the smallest output is cast at the scanning positions X₁, X₅, X₇ and X₁₀ on the photoconductive drum 16 shown in [A] of FIG. 7 from the semiconductor laser oscillator 30 of the first channel. A laser beam is cast from the semiconductor laser oscillator 30 of the second channel so that a laser beam having the third largest output is cast at the scanning positions X₂, X₄ and X₉ on the photoconductive drum 16 shown in [B] of FIG. 7 from the semiconductor laser oscillator 30 of the second channel. A laser beam is cast from the semiconductor laser oscillator 30 of the third channel so that a laser beam having the second largest output is cast at the scanning positions X₆, X₈ and X₁₁ on the photoconductive drum 16 shown in [C] of FIG. 7 from the semiconductor laser oscillator 30 of the third channel. A laser beam is cast from the semiconductor laser oscillator 30 of the fourth channel so that a laser beam having the largest output is cast at the scanning positions X₃ and X₁₂ on the photoconductive drum 16 shown in [D] of FIG. 7 from the semiconductor laser oscillator 30 of the fourth channel.

Thus, as the semiconductor laser oscillators 30 of the four channels scan one line on the photoconductive drum 16, the output distribution of the laser beams case to the photoconductive drum 16 can be made an output distribution as shown in [E] of FIG. 7 and the intensity distribution of the laser beams on the photoconductive drum 16 can be made an intensity distribution corresponding to the output distribution as shown in [E] of FIG. 7.

In step S3, the scanning unit 57 deflects the laser beams emitted by the light emitting unit 56 at a predetermined speed and scans the photoconductive drum 16 with the deflected laser beams.

In step S4, the writing unit 58 irradiates the charged photoconductive drum 16 with the laser beams used for scanning by the scanning unit 57, lowers the potential of the irradiated part, and forms an image (electrostatic latent image) on the photoconductive drum 16 by the lowered potential, thereby writing a desired image.

Parallel to the processing of steps S1 to S4, the laser driver 31 executes APC control so that the preset output is constant in the semiconductor laser oscillator 30 of each channel. Thus, the preset output can be kept constant in the semiconductor laser oscillator 30 of each channel, and for example, as a laser beam is emitted from the semiconductor laser oscillator 30 of the first channel, the output of the laser beam cast on the photoconductive drum 16 can be maintained at a predetermined value.

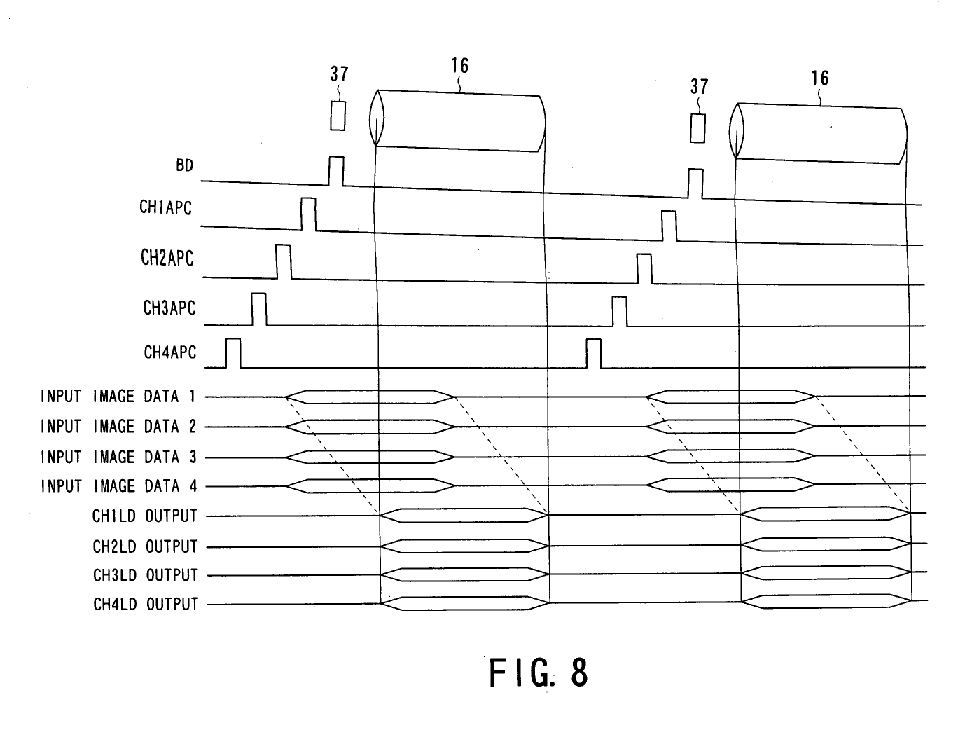

FIG. 8 shows a timing chart up to the point when laser beams are emitted from the semiconductor laser oscillators 30 in the image forming apparatus 1.

As shown in FIG. 8, APC control is carried out in the semiconductor laser oscillator 30 of each channel before forming an image, and then the image data 1 to 4 supplied via the image data interface 46 are synchronized with a new reference clock that is synchronous with a detection signal (BD) supplied from the laser beam detecting circuit 38. On the basis of the synchronized image data, laser beam output setting signals for switching on/off the outputs of the semiconductor laser oscillators 30 of the respective channels at predetermined positions and thereby varying and setting the outputs of the laser beams cast to the photoconductive drum 16 are generated so that the output distribution of the laser beams cast to the photoconductive drum 16 becomes a predetermined output distribution. The semiconductor laser oscillator 30 of each channel emits a laser beam at a predetermined position on the basis of the laser beam output setting signal.

In the first embodiment of this invention, the scanning positions of laser beams from the semiconductor laser oscillators 30 of four channels that are preset at predetermined outputs are arranged on the same line at predetermined intervals in time series in the main scanning direction. On the basis of image data, the outputs of the semiconductor laser oscillators 30 of the respective channels are switched on/off at predetermined positions so that the output distribution of the laser beams cast to the photoconductive drum 16 becomes a predetermined output distribution, and the laser beams are emitted from the semiconductor laser oscillators 30 of the preset and predetermined outputs. Therefore, irradiation with predetermined laser power in accordance with the position (area) on the photoconductive drum 16 can be set, and consequently the outputs of the laser beams cast to the photoconductive drum 16 can be controlled at a high speed. Thus, the predetermined laser beam intensity can be achieved on the photoconductive drum 16, and the intensity of the laser beams on the photoconductive drum 16 can be controlled at a high speed. Accordingly, an image of predetermined gradation can be formed on the photoconductive drum 16 without using a pulse width modulation system, and a preferable image can be formed.

For example, in the case where the output of the semiconductor laser oscillator 30 of the first channel and the output of the semiconductor laser oscillator 30 of the fourth channel, of the outputs of the semiconductor laser oscillators 30 of the four channels, are the same output (for example, 5 mW or the like), if it is detected by the laser beam detection sensor 37 or the like that one of the semiconductor laser oscillators 30 (for example, the semiconductor laser oscillator 30 of the first channel) cannot emit a laser beam because of failure, degradation with time, expiration of life or the like, the semiconductor laser oscillator 30 of the fourth channel having the same output may emit a laser beam instead of the semiconductor laser oscillator 30 of the first channel so that irradiation with predetermined laser power in accordance with the position (area) on the photoconductive drum 16 can be set. Of course, it is not limited to the same output, and another semiconductor laser oscillator 30 having a proximate output may be substituted.

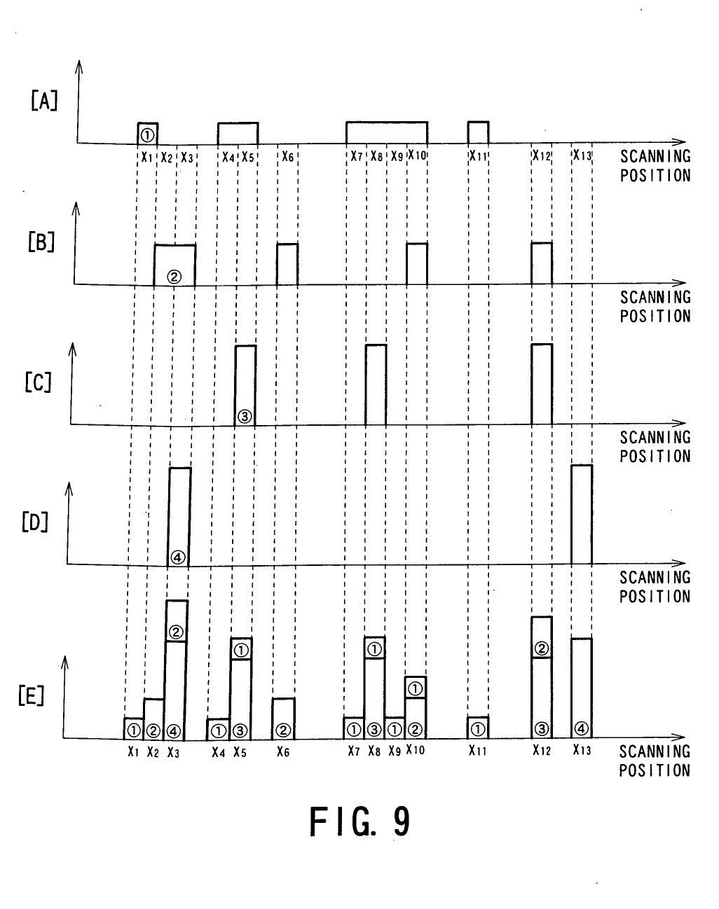

In the example of FIG. 7, the laser beams from the semiconductor laser oscillators 30 of the first to fourth channels are emitted at the scanning positions that are different by channel (that is, laser beams of different channels are not emitted to the same scanning position). However, it is not limited to this case. For example, as shown in FIG. 9, laser beams of preset and predetermined outputs may be emitted overlapping at the same scanning position, and the output of the laser beam cast onto the photoconductive drum 16 may be formed by a combination of outputs of plural laser beams.

For example, in the example of FIG. 9, a laser beam is emitted from the semiconductor laser oscillator 30 of the first channel so that a laser beam having the smallest output is cast at scanning positions Y₁, Y₄, Y₅, X₇, Y₈, Y₉, X₁₀ and X₁₁ shown in [A] of FIG. 9 from the semiconductor laser oscillator 30 of the first channel. A laser beam is emitted from the semiconductor laser oscillator 30 of the second channel so that a laser beam having the third largest output is cast at scanning positions Y₂, Y₃, Y₆, X₁₀ and X₁₂ shown in [B] of FIG. 9 from the semiconductor laser oscillator 30 of the second channel. A laser beam is emitted from the semiconductor laser oscillator 30 of the third channel so that a laser beam having the second largest output is cast at scanning positions Y₅, Y₈ and X₁₂ shown in [C] of FIG. 9 from the semiconductor laser oscillator 30 of the third channel. A laser beam is emitted from the semiconductor laser oscillator 30 of the fourth channel so that a laser beam having the largest output is cast at scanning positions Y₃ and X₁₂ shown in [D] of FIG. 9 from the semiconductor laser oscillator 30 of the fourth channel.

In this manner, as one line on the photoconductive drum 16 is scanned using the semiconductor laser oscillators 30 of the four channels having the preset and predetermined outputs, the output distribution of the laser beams cast on the photoconductive drum 16 can be made an output distribution as shown in [E] of FIG. 9, and the intensity distribution of the laser beams on the photoconductive drum 16 can be made an intensity distribution corresponding to the output distribution as shown in [E] of FIG. 9. For example, at the scanning position Y₃ on the photoconductive drum 16, the laser beam of the third largest output from the semiconductor laser oscillator 30 of the second channel and the laser beam of the largest output from the semiconductor laser oscillator 30 of the fourth channel are cast, and the laser beam intensity corresponding to the laser beam output formed by superimposing the laser beam of the third largest output and the laser beam of the largest output can be provided.

Thus, the laser beams cast on the photoconductive drum 16 can be controlled at a high-speed and highly finely, and the intensities of the laser beams on the photoconductive drum 16 can be controlled at a high speed and highly finely. As a result, an image having more gradation levels can be formed on the photoconductive drum 16 without using the pulse width modulation system, and a finer image can be formed. Also, since two or more laser beams are superimposed depending on the scanning position, if the quantity of light is insufficient, the quantity of light can be supplemented to realize a required quantity of light.

In the case of emitting laser beams of preset and predetermined outputs in a superimposing manner at the same scanning position, the outputs of the semiconductor laser oscillators 30 of the first to fourth channels may be the same outputs. Alternatively, all the four outputs may be different. For example, even if the outputs of the semiconductor laser oscillators 30 of the first to fourth channels are the same outputs, the intensity of the laser beams cast onto the photoconductive drum 16 can be changed and set in four stages because the laser beams are emitted in a superimposing manner at the same scanning position. As a result, the laser beams cast onto the photoconductive drum 16 can be controlled at a high speed and highly finely.

On the other hand, if all the outputs of the semiconductor laser oscillators 30 of the first to fourth channels are different outputs, the intensity of the laser beams cast onto the photoconductive drum 16 can be changed and set at least in five stages or more. As a result, the laser beams cast onto the photoconductive drum 16 can be controlled at a high speed and highly finely. For example, if the outputs of the semiconductor laser oscillators 30 of the first to fourth channels are 1 mW, 2 mW, 5 mW and 7 mW, the intensity can be changed and set in 13 stages of 1 mW, 2 mW, 3 mW, 5 mW, 6 mW, 7 mW, 8 mW, 9 mW, 10 mW, 12 mW, 13 mW, 14 mW and 15 mW by combinations of superimposed outputs. Consequently, the laser beams cast onto the photoconductive drum 16 can be controlled at a high speed and more finely.

The power control processing described with reference to the flowchart of FIG. 6 may be executed in combination with pulse modulation processing using the pulse width modulation (PWM) system. Hereinafter, a second embodiment of this invention incorporating the pulse width modulation processing will be described.

### Second Embodiment

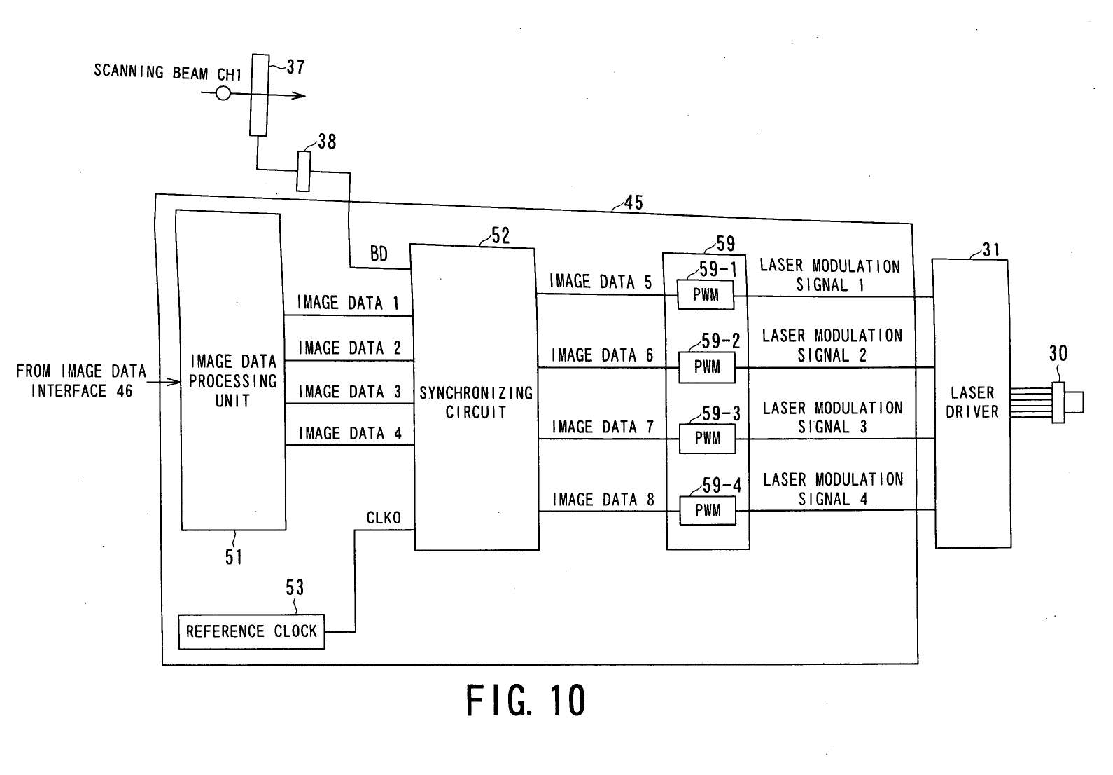

FIG. 10 shows a detailed internal configuration of the laser control unit 45 of FIG. 3. The other parts of the configuration are similar to those described in the first embodiment and therefore will not be described further in order to avoid repetition.

As shown in FIG. 10, the laser control unit 45 further includes PWMs 59 (59-1 to 59-4), in addition to the image data processing unit 51, the synchronizing circuit 52 and the reference clock 53.

The synchronizing circuit 52 acquires image data (image data 1 to 4) for the respective semiconductor laser oscillators 30 supplied from the image data processing unit 51, and generates a new reference clock synchronized with a detection signal (BD) supplied from the laser beam detecting circuit 38 on the basis of a reference clock (CLKO) supplied from the reference clock 53.

The synchronizing circuit 52 synchronizes the acquired image data (image data 1 to 4) for the respective semiconductor laser oscillators 30 with the generated new reference clock and supplies the image data (image data 5 to 8) synchronized with the new reference clock to the PWMs 59 (59-1 to 59-4).

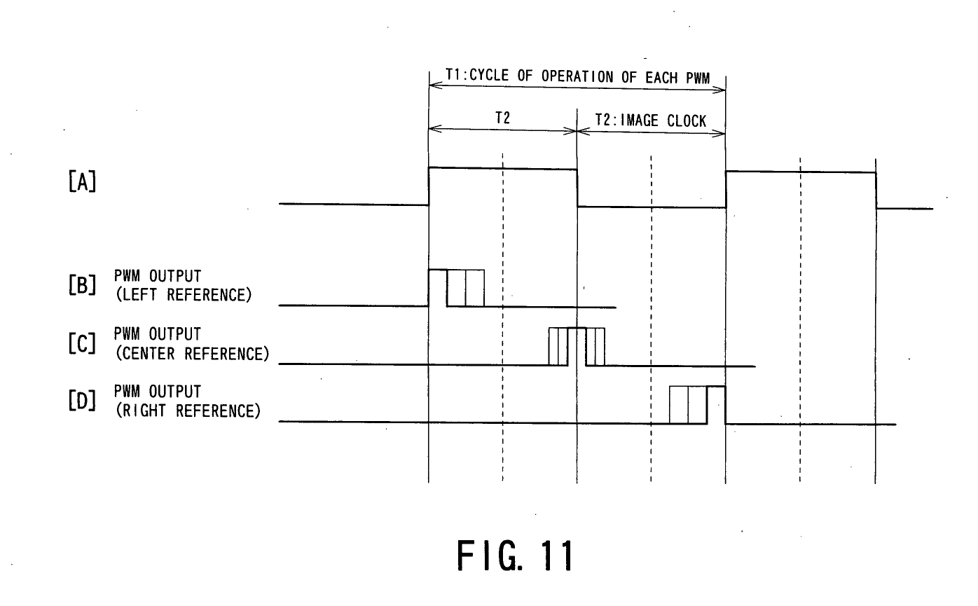

The PWMs 59-1 to 59-4 acquire the image data (image data 5 to 8) synchronized with the new reference clock, supplied from the synchronizing circuit 52, and adjust the pulse width in accordance with the acquired image data synchronized with the reference clock and also adjust the pulse position (left reference, center reference, right reference) as shown in FIG. 11. The PWMs 59-1 to 59-4 output the image data with their pulse widths and pulse positions adjusted, as laser modulation signals (laser modulation signals 1 to 4), to the laser driver 31.

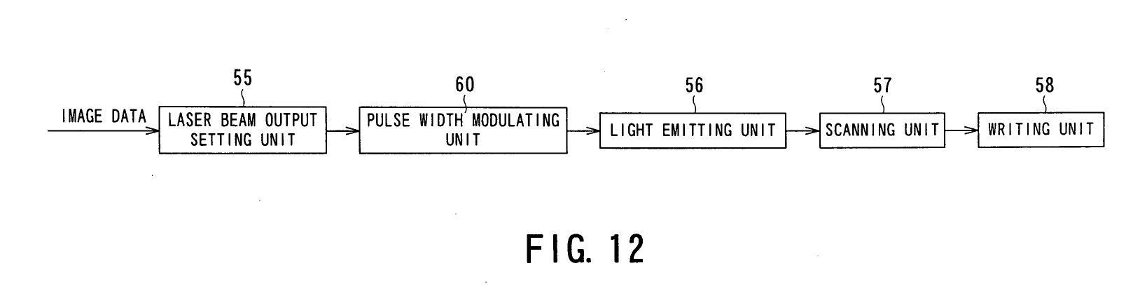

FIG. 12 shows a functional configuration that can be executed in the second embodiment of the image forming apparatus 1 according to this invention. The elements corresponding to those shown in FIG. 5 are denoted by the same numerals and will not be described further in order to avoid repetition.

The laser beam output setting unit 55 includes, for example, the image data processing unit 51, the synchronizing circuit 52 and the reference clock 53 of FIG. 5 and the like. The laser beam output setting unit 55 acquires image data supplied from the image processing unit 47 via the image data interface 46 and synchronizes the acquired image data (image data 1 to 4) for each semiconductor laser oscillator 30 with a new reference clock generated on the basis of a reference clock supplied from the reference clock 53. On the basis of the synchronized image data, the laser beam output setting unit 55 generates a laser beam output setting signal for switching on/off the output of the semiconductor laser oscillator 30 of each channel at a predetermined position and thereby changing and setting the output of the laser beams cast onto the photoconductive drum 16 so that the output distribution of the laser beams cast onto the photoconductive drum 16 becomes a predetermined output distribution, and supplies the generated laser beam output setting signal to a pulse modulating unit 60.

The pulse modulating unit 60 includes, for example, the PWMs 59-1 to 59-4 of FIG. 10. The pulse modulating unit 60 acquires the laser beam output setting signal supplied from the laser beam output setting unit 55, adjusts the pulse width in accordance with the image data synchronized with the new reference clock included in the acquired laser beam setting signal and also adjusts the pulse position, and supplies the laser beam output setting signal with its pulse width and pulse position adjusted, to the light emitting unit 56.

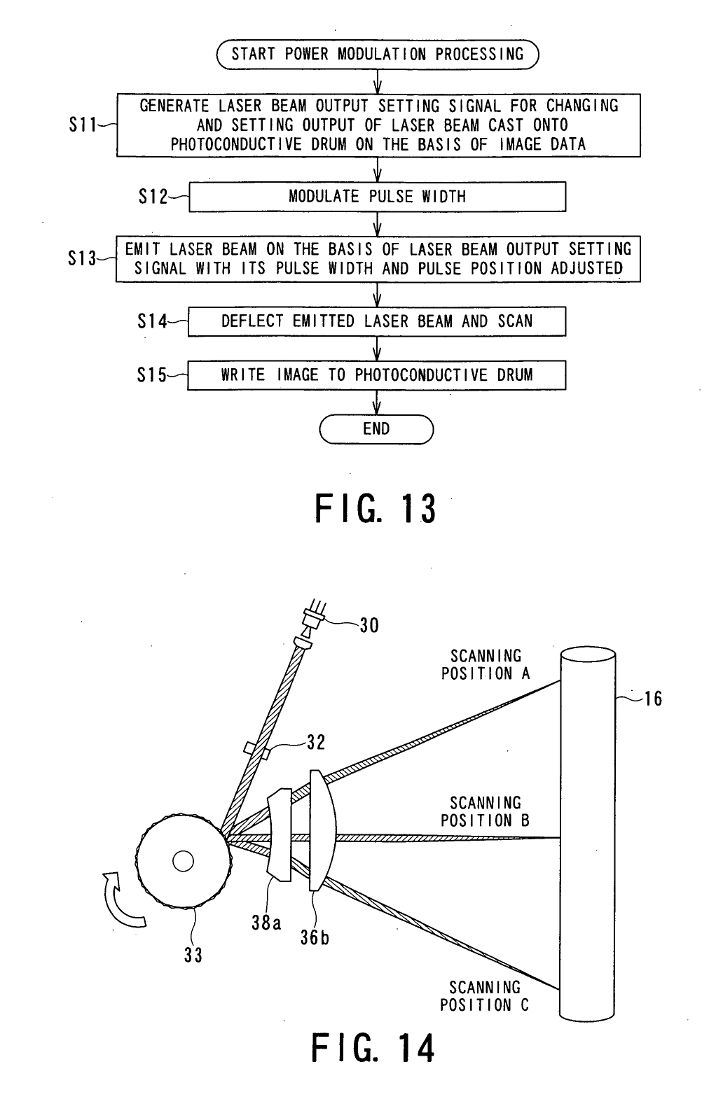

Next, the power control processing in the image forming apparatus 1 of FIG. 12 will be described with reference to the flowchart of FIG. 13. The processing of steps S13 to S15 of FIG. 13 is similar to the processing of steps S3 to S5 of FIG. 6 and therefore will not be described further in order to avoid repetition.

In step S11, the laser beam output setting unit 55 acquires image data supplied from the image processing unit 47 via the image data interface 46 and synchronizes the acquired image data (image data 1 to 4) for each semiconductor laser oscillator 30 with a new reference clock generated on the basis of a reference clock supplied from the reference clock 53. On the basis of the synchronized image data, the laser beam output setting unit 55 generates a laser beam output setting signal for switching on/off the output of the semiconductor laser oscillator 30 of each channel at a predetermined position and thereby changing and setting the output of the laser beam cast onto the photoconductive drum 16 so that the output distribution of laser beams cast onto the photoconductive drum 16 becomes a predetermined output distribution, and supplies the generated laser beam output setting signal to the pulse modulating unit 60.

In step S12, the pulse modulating unit 60 acquires the laser beam output setting signal supplied from the laser beam output setting unit 55, adjusts the pulse width in accordance with the image data synchronized with the new reference clock included in the acquired laser beam output setting signal and also adjusts the pulse position, and generates a laser beam output setting signal with its pulse width and pulse position adjusted.

Specifically, for example, laser beams are cast from the semiconductor laser oscillators 30 of the first to fourth channels at the scanning positions X₁ to X₁₂ on the photoconductive drum 16 as shown in [A] to [D] of FIG. 7, and a laser beam output setting signal to realize a predetermined pulse width and pulse position is generated as shown in FIG. 11.

The pulse width modulating unit 60 supplies the generated laser beam output setting signal to the light emitting unit 56.

After that, light emitting processing, scanning processing and writing processing are executed in steps S13 to S15.

In the second embodiment of this invention, since the power control processing is carried out in combination with the pulse modulation processing using the pulse width modulation (PWM) system, irradiation with predetermined laser power in accordance with the position (area) on the photoconductive drum 16 is set. Consequently the output of the laser beams cast on the photoconductive drum 16 is controlled at a high speed, the intensity of the laser beams on the photoconductive drum 16 is controlled at a high speed, and the pulse width is modulated. Thus, a highly fine image of one pixel or less can be formed. Accordingly, an image of predetermined gradation levels can be formed on the photoconductive drum 16 by using both the power control processing and the pulse width modulation processing, and a preferable and finer image can be formed.

In the case where the pulse width processing is combined with the power control processing in which the intensities of plural laser beams are superimposed as shown in FIG. 8, the pulse position adjusted by the pulse width modulating unit 60 is adjusted by the same reference for any laser beam to be superimposed at the same scanning position. That is, if the right reference is used, the pulse position is adjusted by the right reference. Thus, a predetermined intensity of laser beam can be achieved on the photoconductive drum 16.

By the way, generally, the laser oscillating unit of the image forming apparatus 1 is equipped with the APC (auto power control) function, and in the laser oscillating unit, the output of the laser oscillating unit is controlled to be constant while the intensity of laser beams is monitored by a photodetector provided within the laser oscillating unit (or a photodetector provided near the laser oscillating unit).

However, even if the output of the laser oscillating unit is constant, the intensity of the laser beam cast onto the photoconductive drum 16 is not necessarily constant because the transmission loss due to the fθ lens 38 (38a and 38b) or the like differs depending on the incident angle of the laser beam. That is, in the case of the fθ lens 38 having a shape as shown in FIG. 14, the incident angle of the laser beam on the fθ lens 38 is substantially 90 degrees at a central part of the fθ lens 38 corresponding to the scanning position B, but it gradually decreases from 90 degrees toward the edges of the fθ lens 38 corresponding to the scanning positions A and C and the laser beam is incident there obliquely to the fθ lens 38. Therefore, the transmission loss due to the fθ lens 38 or the like is the least at the central part and increases toward the edges.

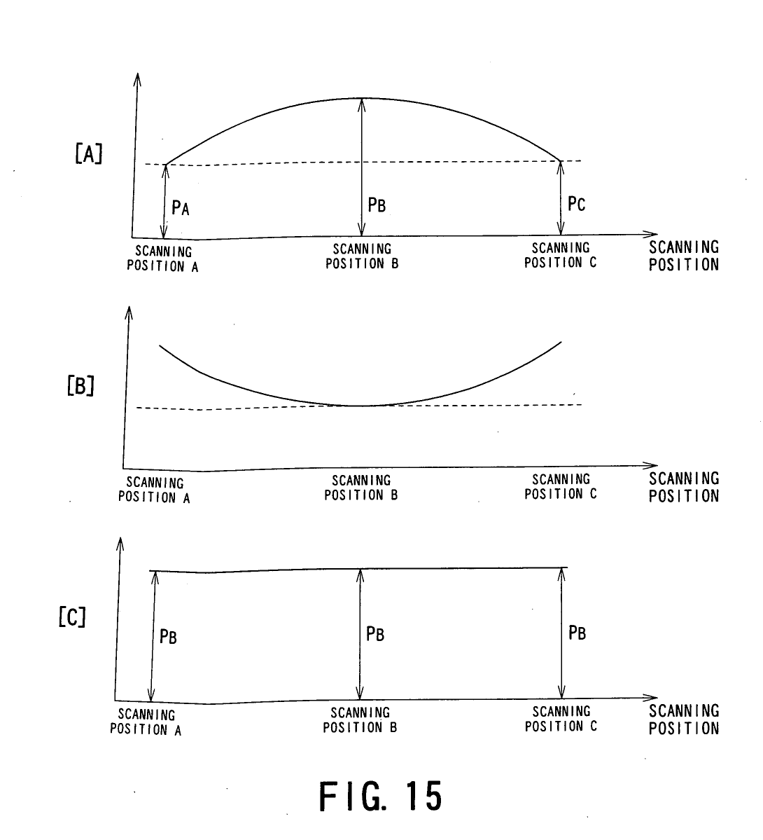

As a result, even if the output of the laser oscillating unit is APC-controlled to be constant, the intensity of the laser beam cast onto the photoconductive drum 16 is the maximum at the central part (scanning position B) of the fθ lens 38 (laser beam intensity P_{B}) and decreases toward the edges (scanning positions A and C)(laser beam intensities P_{A} and P_{C}), for example, as shown in [A] of FIG. 15. In other words, the laser beam intensity on the photoconductive drum 16 primitively has unevenness due to the shape of the fθ lens 38, and the output distribution of the laser beams cast onto the photoconductive drum 16 does not coincide with the intensity distribution of the laser beams on the photoconductive drum 16.

Conventionally, as a method for correcting such unevenness in the laser beam intensity in the main scanning direction, a technique of adjusting the thickness and type of a coating layer of the fθ lens 38 and thereby making the optical transmission loss uniform so that the laser beam intensity on the photoconductive drum 16 becomes uniform, has been proposed.

However, in this technique, not only the processing of the fθ lens 38 is time-consuming but also it causes increase in the cost of the image forming apparatus 1.

Thus, using the power control processing described with reference to the flowchart of FIG. 6, the output of the laser beam on the photoconductive drum 16 may be modulated to realize uniform laser beam intensity on the photoconductive drum 16 in consideration of the degree of transmission loss due to the fθ lens 38 or the like.

That is, for example, in the case of modulating the laser beam intensity to be uniform at any scanning position on the photoconductive drum 16, laser beams are emitted from the respective semiconductor laser oscillators 30 of the first to fourth channels so that the output distribution of the laser beams cast onto the photoconductive drum 16 becomes an output distribution as shown in [B] of FIG. 15. In this way, uniform laser beam intensity (laser beam intensity P_{B}) can be achieved at any scanning position on the photoconductive drum 16, as shown in [C] of FIG. 15. Hereinafter, a third embodiment of this invention using this power control processing will be described.

### Third Embodiment

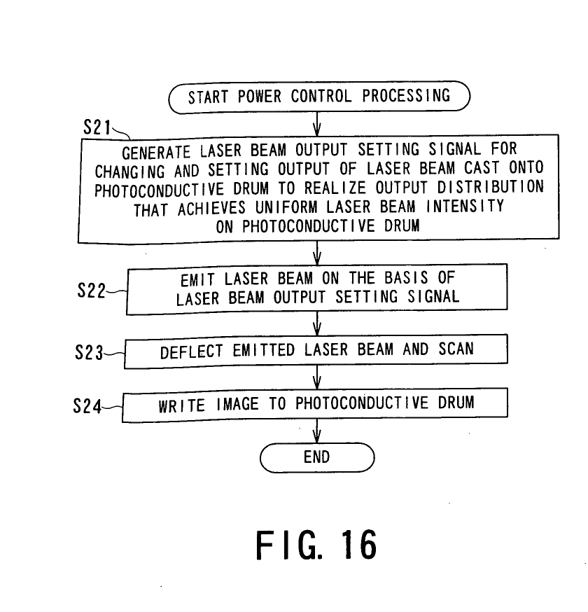

Another power control processing in the image forming apparatus 1 of FIG. 5 will be described with reference to the flowchart of FIG. 16. The configuration of the image forming apparatus 1 in the third embodiment is basically similar to the configuration of the image forming apparatus 1 in the first embodiment and therefore it will not be described further in order to avoid repetition. In the power control processing described with reference to the flowchart of FIG. 16, image data that requires uniform laser beam intensity on the photoconductive drum 16 is used.

In step S21, the laser beam output setting unit 55 acquires image data supplied from the image processing unit 47 via the image data interface 46, synchronizes the acquired image data (image data 1 to 4) for each semiconductor laser oscillator 30 with a new reference clock generated on the basis of a reference clock supplied form the reference clock 53, and on the basis of the synchronized image data, generates a laser beam output setting signal for switching on/off the output of the semiconductor laser oscillator 30 of each channel at a predetermined position and thereby changing and setting the output of the laser beam cast onto the photoconductive drum so that the output distribution of the laser beams cast onto the photoconductive drum 16 becomes an output distribution that achieves uniform laser beam intensity on the photoconductive drum 16.

Specifically, on the basis of the synchronized image data, a laser beam output setting signal is generated such that a laser beam is cast, for example, at scanning positions Z₄ and Z₅ on the photoconductive drum 16 as shown in [A] of FIG. 17, from the semiconductor laser oscillator 30 of the first channel having the smallest laser beam output of the semiconductor laser oscillators 30 of the four channels. Similarly, a laser beam output setting signal is generated such that a laser beam is cast at scanning positions Z₃ and Z₆ on the photoconductive drum 16 as shown in [B] of FIG. 17 from the semiconductor laser oscillator 30 of the second channel having the third largest laser beam output of the semiconductor laser oscillators 30 of the four channels. A laser beam output setting signal is generated such that a laser beam is cast at scanning positions Z₂ and Z₇ on the photoconductive drum 16 as shown in [C] of FIG. 17 from the semiconductor laser oscillator 30 of the third channel having the second largest laser beam output of the semiconductor laser oscillators 30 of the four channels. A laser beam output setting signal is generated such that a laser beam is cast at scanning positions Z₁ and Z₈ on the photoconductive drum 16 as shown in [D] of FIG. 17 from the semiconductor laser oscillator 30 of the fourth channel having the largest laser beam output of the semiconductor laser oscillators 30 of the four channels.

The laser beam output setting unit 55 outputs the generated laser beam output setting signals to the laser driver 31.

In step S22, the light emitting unit 56 acquires the laser beam output setting signals supplied from the laser beam output setting unit 55 and emits laser beams of preset and predetermined outputs so that the laser beams of the preset and predetermined outputs are cast at predetermined positions on the photoconductive drum 16, on the basis of the acquired laser beam output setting signals. That is, a laser beam is emitted from the semiconductor laser oscillator 30 of the first channel so that the smallest laser beam is cast at the scanning positions Z₄ and Z₅ shown in [A] of FIG. 17 from the semiconductor laser oscillator 30 of the first channel. A laser beam is emitted from the semiconductor laser oscillator 30 of the second channel so that the third largest laser beam is cast at the scanning positions Z₃ and Z₆ shown in [B] of FIG. 17 from the semiconductor laser oscillator 30 of the second channel. A laser beam is emitted from the semiconductor laser oscillator 30 of the third channel so that the second largest laser beam is cast at the scanning positions Z₂ and Z₇ shown in [C] of FIG. 17 from the semiconductor laser oscillator 30 of the third channel. A laser beam is emitted from the semiconductor laser oscillator 30 of the fourth channel so that the largest laser beam is cast at the scanning positions Z₁ and Z₈ shown in [D] of FIG. 17 from the semiconductor laser oscillator 30 of the fourth channel.

Thus, as the semiconductor laser oscillators 30 of the four channels are caused to scan one line on the photoconductive drum 16, the output distribution of the laser beams cast onto the photoconductive drum 16 can be made an output distribution as shown in [E] of FIG. 17.

In step S23, the scanning unit 57 deflects the laser beams emitted from the light emitting unit 56 at a predetermined speed and scans the photoconductive drum 16 with the deflected laser beams.

In step S24, the writing unit 58 irradiates the charged photoconductive drum 16 with the laser beams used for scanning by the scanning unit 57, lowers the potential of the irradiated part, and forms an image (electrostatic latent image) on the photoconductive drum 16 by the lowered potential, thereby writing a desired image.

In the third embodiment of this invention, the scanning positions of the laser beams from the semiconductor laser oscillators 30 of the four channels set at predetermined outputs are arrayed on the same line at predetermined intervals in time series in the main scanning direction. On the basis of the image data, the outputs of the semiconductor laser oscillators 30 of the respective channels are switched on/off at predetermined positions so that the output distribution of the laser beams cast onto the photoconductive drum 16 becomes an output distribution that achieves uniform laser beam intensity on the photoconductive drum 16, and the laser beams are emitted from the semiconductor laser oscillators 30 of the preset and predetermined outputs. Therefore, irradiation with predetermined laser power is set in accordance with the position (area) on the photoconductive drum 16. As a result, the outputs of the laser beams cast onto the photoconductive drum 16 can be controlled at a high speed. Also, as the transmission loss due to the fθ lens 38 or the like is corrected, the laser beam intensity on the photoconductive drum 16 can be made uniform. Thus, an image of uniform density can be formed.

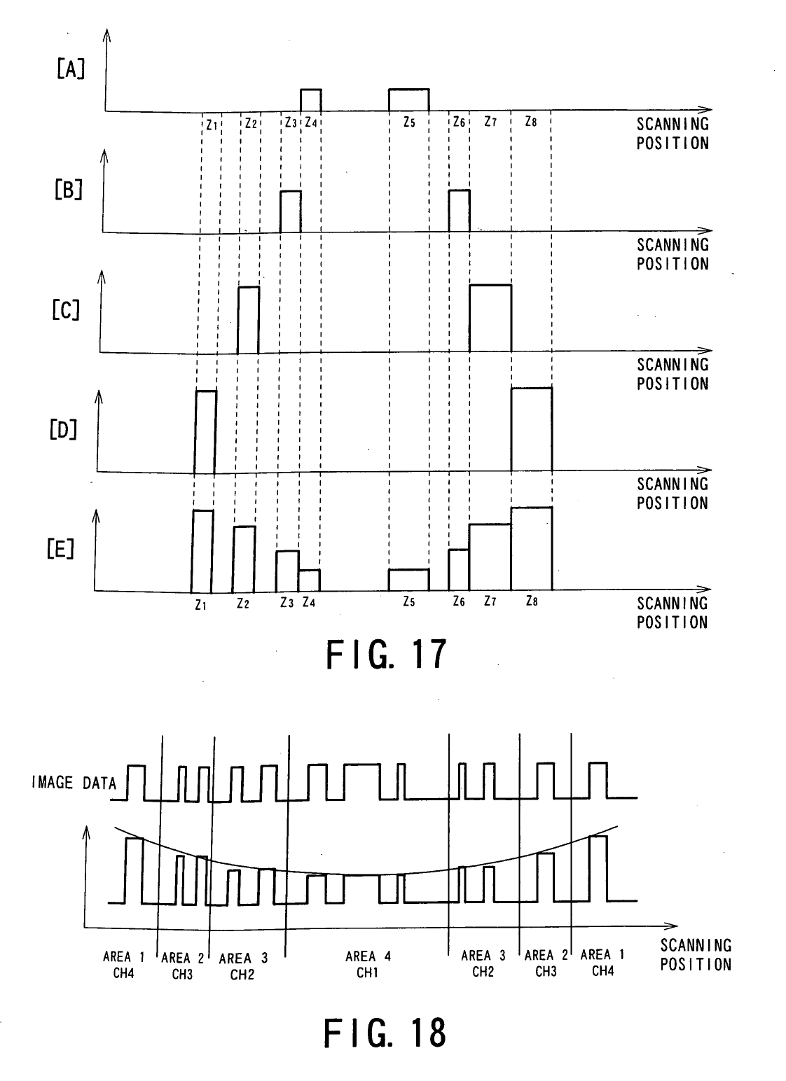

As shown in FIG. 18, an area 1 where the transmission loss due to the fθ lens 38 or the like largely changes (area where the output of the laser beam is increased to correct the transmission loss) may be narrow, and an area 4 where the transmission loss due to the fθ lens 38 or the like changes less (area where the output of the laser beam is hardly increased and the transmission loss is hardly corrected) may be broad (that is, the respective areas may hold area 1<area 2<area 3<area 4). Thus, the transmission loss due to the fθ lens 38 can be correctly highly accurately and the laser beam intensity on the photoconductive drum 16 can be made uniform more accurately. Accordingly, an image of more uniform density can be formed.

Also in the third embodiment of this invention, laser beams of preset different outputs may be emitted in a superimposing manner at the same scanning direction and the output of laser beams cast onto the photoconductive drum 16 may be formed by a combination of the plural laser beam outputs, for example, as shown in FIG. 9. In this way, the output of the laser beams cast onto the photoconductive drum 16 can be controlled at a high speed, and as the transmission loss due to the fθ lens 38 or the like is corrected with high accuracy, the laser beam intensity on the photoconductive drum 16 can be made more uniform. Thus, an image of more uniform density can be formed.

Moreover, though image data that requires uniform laser beam intensity on the photoconductive drum 16 is used in the power control processing described with reference to the flowchart of FIG. 16, it is not limited to such case and image data that requires non-uniform laser beam intensity on the photoconductive drum 16 (that is, image data that requires plural gradation levels on the photoconductive drum 16) may also be used. In this case, the output of the laser beams on the photoconductive drum 16 is controlled on the basis of the image data while the degree of transmission loss due to the fθ lens 38 or the like is considered.

That is, in the case of controlling to predetermined laser beam intensity on the photoconductive drum 16 on the basis of the image data, the output distribution of the laser beams based on the image data is multiplied by the proportion of each scanning position based on the output at the scanning position B in the output distribution as shown in [B] of FIG. 15, and a laser beam is emitted from each of the semiconductor laser Oscillators 30 of the first to fourth channels. In this way, the output of the laser beams on the photoconductive drum 16 can be controlled at a high speed on the basis of the image data while the degree of transmission loss due to the fθ lens 38 or the like is considered.

Thus, predetermined laser beam intensity can be achieved on the photoconductive drum 16 while the transmission loss due to the fθ lens 38 or the like is corrected. The laser beam intensity on the photoconductive drum 16 can be controlled at a high speed. Therefore, an image of predetermined gradation levels can be formed on the photoconductive drum 16 without using the pulse width modulation system, and a more preferable image can be formed.

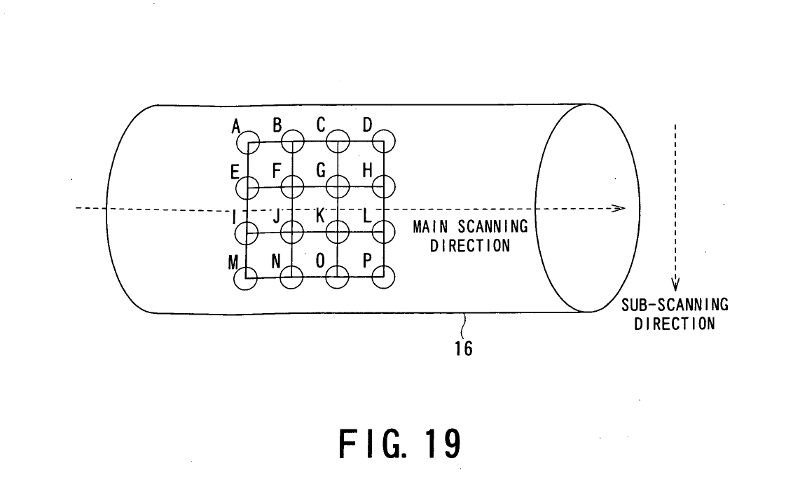

In the first to third embodiments of this invention, the semiconductor laser oscillators 30 of four channels are used that are arranged in advance so that the scanning positions of the laser beams are arrayed on the same line at predetermined intervals in time series in the main scanning direction, such as the scanning positions A, B, C and D of FIG. 2. However, it is not limited to such case, and plural semiconductor laser oscillators 30 (surface emitting lasers) may be used that are arranged in advance so that the scanning positions of the laser beams are arrayed in a two-dimensional matrix (arrayed at predetermined intervals in time series in the main scanning direction and in the sub-scanning direction) for example, as shown in FIG. 19.

The series of processing described in the embodiments of this invention can be executed by software and can also be executed by hardware.

In the embodiments of this invention, the steps in the flowcharts represent exemplary processing that is carried out in time series in the described order. However, the processing is not necessarily carried out in time series and it includes processing executed in parallel or individually.

What is claimed is:

1. An optical beam scanning apparatus comprising:
a light emitting unit for emitting plural laser beams set at a predetermined output in advance;
a scanning unit for deflecting the plural laser beams emitted by the light emitting unit and scanning with the plural laser beams;
an output setting unit for arranging the light emitting unit so that scanning positions of the plural laser beams by the scanning unit are arrayed in time series in a main scanning direction on the same line, and for setting an output of the laser beams cast onto a photoconductor by using the plural laser beams; and
a writing unit for writing an image to the photoconductor with the output of the laser beams cast onto the photoconductor set by the output setting unit, using the plural laser beams used for the scanning by the scanning unit.

2. The optical beam scanning apparatus according to claim 1, wherein the output setting unit sets the output of the laser beams cast onto the photoconductor by using the plural laser beams, on the basis of image data.

3. The optical beam scanning apparatus according to claim 1, wherein the output setting unit sets the output of the laser beams cast onto the photoconductor by using the plural laser beams and superimposing the plural laser beams set at a predetermined output in advance, at the same scanning position.

4. The optical beam scanning apparatus according to claim 1, further comprising a pulse width modulation unit for modulating pulse widths of the plural laser beams emitted by the light emitting unit,
wherein the output setting unit sets the output of the laser beams cast onto the photoconductor by using the plural laser beams with their pulse widths modulated by the pulse width modulation unit.

5. The optical beam scanning apparatus according to claim 1, wherein in accordance with optical loss in writing an image to the photoconductor using the plural laser beams by the writing unit, the output setting unit sets the output of the laser beams cast onto the photoconductor by using the plural laser beams so that laser beam intensity on the photoconductive becomes substantially uniform.

6. The optical beam scanning apparatus according to claim 5, wherein in the case of setting the output of the laser beams cast onto the photoconductor by using the plural laser beams so that laser beam intensity on the photoconductor becomes substantially uniform, the output of the laser beams cast onto the photoconductor is set by narrowing an area where the optical loss changes largely and broadening an area where the optical loss changes little.

7. The optical beam scanning apparatus according to claim 1, wherein the output setting unit selectively uses the plural laser beams, thereby setting the output of the laser beams cast onto the photoconductor.

8. The optical beam scanning apparatus according to claim 7, wherein when failure is detected in the light emitting unit that emits one of the plural laser beams, the output setting unit uses another laser beam of the plural laser beams as a replacement, thereby setting the output of the laser beams cast onto the photoconductor.

9. An optical beam scanning method comprising the steps of:
emitting plural laser beams set at a predetermined output in advance;
deflecting the plural laser beams emitted by a light emitting processing and scanning with the plural laser beams;
arranging a light emitting unit so that scanning positions of the plural laser beams by the scanning processing are arrayed in time series in a main scanning direction on the same line, and setting an output of the laser beams cast onto a photoconductor by using the plural laser beams; and
writing an image to the photoconductor with the output of the laser beams cast onto the photoconductor set by the output setting processing, using the plural laser beams used for the scanning in the scanning processing.

10. An optical beam scanning program for an optical beam scanning apparatus, the program causing a computer to execute the steps of:
emitting plural laser beams set at a predetermined output in advance;
deflecting the plural laser beams emitted by a light emitting processing and scanning with the plural laser beams;
arranging a light emitting unit so that scanning positions of the plural laser beams by the scanning processing are arrayed in time series in a main scanning direction on the same line, and setting an output of the laser beams cast onto a photoconductor by using the plural laser beams; and
writing an image to the photoconductor with the output of the laser beams cast onto the photoconductor set by the output setting processing, using the plural laser beams used for the scanning in the scanning processing.

11. An image forming apparatus comprising:
a light emitting unit for emitting plural laser beams set at a predetermined output in advance;
a scanning unit for deflecting the plural laser beams emitted by the light emitting unit and scanning with the plural laser beams;
an output setting unit for arranging the light emitting unit so that scanning positions of the plural laser beams by the scanning unit are arrayed in time series in a main scanning direction on the same line, and for setting an output of the laser beams cast onto a photoconductor by using the plural laser beams; and
a writing unit for writing an image to the photoconductor with the output of the laser beams cast onto the photoconductor set by the output setting unit, using the plural laser beams used for the scanning by the scanning unit.

12. The image forming apparatus according to claim 11, wherein the output setting unit sets the output of the laser beams cast onto the photoconductor by using the plural laser beams, on the basis of image data.

13. The image forming apparatus according to claim 11, wherein the output setting unit sets the output of the laser beams cast onto the photoconductor by using the plural laser beams and superimposing the plural laser beams set at a predetermined output in advance, at the same scanning position.

14. The image forming apparatus according to claim 11, further comprising a pulse width modulation unit for modulating pulse widths of the plural laser beams emitted by the light emitting unit,
wherein the output setting unit sets the output of the laser beams cast onto the photoconductor by using the plural laser beams with their pulse widths modulated by the pulse width modulation unit.

15. The image forming apparatus according to claim 11, wherein in accordance with optical loss in writing an image to the photoconductor using the plural laser beams by the writing unit, the output setting unit sets the output of the laser beams cast onto the photoconductor by using the plural laser beams so that laser beam intensity on the photoconductive becomes substantially uniform.

16. The image forming apparatus according to claim 15, wherein in the case of setting the output of the laser beams cast onto the photoconductor by using the plural laser beams so that laser beam intensity on the photoconductor becomes substantially uniform, the output of the laser beams cast onto the photoconductor is set by narrowing an area where the optical loss changes largely and broadening an area where the optical loss changes little.

17. The image forming apparatus according to claim 11, wherein the output setting unit selectively uses the plural laser beams, thereby setting the output of the laser beams cast onto the photoconductor.

18. The image forming apparatus according to claim 17, wherein when failure is detected in the light emitting unit that emits one of the plural laser beams, the output setting unit uses another laser beam of the plural laser beams as a replacement, thereby setting the output of the laser beams cast onto the photoconductor.

19. An image forming method including an optical beam scanning method comprising the steps of:
emitting plural laser beams set at a predetermined output in advance;
deflecting the plural laser beams emitted by a light emitting processing and scanning with the plural laser beams;
arranging a light emitting unit so that scanning positions of the plural laser beams by the scanning processing are arrayed in time series in a main scanning direction on the same line, and setting an output of the laser beams cast onto a photoconductor by using the plural laser beams; and
writing an image to the photoconductor with the output of the laser beams cast onto the photoconductor set by the output setting processing, using the plural laser beams used for the scanning in the scanning processing.

20. An image forming program for an image forming apparatus having an optical beam scanning apparatus, the program causing a computer to execute the steps of:
emitting plural laser beams set at a predetermined output in advance;
deflecting the plural laser beams emitted by a light emitting processing and scanning with the plural laser beams;
arranging a light emitting unit so that scanning positions of the plural laser beams by the scanning processing are arrayed in time series in a main scanning direction on the same line, and setting an output of the laser beams cast onto a photoconductor by using the plural laser beams; and
writing an image to the photoconductor with the output of the laser beams cast onto the photoconductor set by the output setting processing, using the plural laser beams used for the scanning in the scanning processing.
